(19) United States
(12) Patent Application Publication
(10) Pub. No.: US 2004/0085869 A1
(43) Pub. Date: May 6, 2004

(54) Optical disk apparatus

(75) Inventors: Shintaro Takehara, Yokohama-shi (JP); Hideyuki Yamakawa, Kawasaki-shi (JP); You Yoshioka, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/680,184

(22) Filed: Oct. 8, 2003

(30) Foreign Application Priority Data
Oct. 31, 2002 (JP) 2002-318862

(51) Int. Cl. G11B 7/00

(52) U.S. Cl. 369/44.32; 369/59.22; 369/44.35; 369/53.19

(57) ABSTRACT

A focus offset setting portion gives a predetermined quantity of offset to a focus control quantity used to reduce a focus error signal to zero based on the focus error signal generated by a focus error generation portion, and outputs a result. An adaptive equalizer including an adaptive control portion and an FIR filter subjects a reproduction signal RF provided from an optical pickup to waveform equalization based on a signal decoded by a Viterbi decoder. A controller obtains an optimum point of a focus offset by using a tap coefficient of the adaptive equalizer, and changes a set value of a focus offset setting portion.

### CROSS-REFERENCE TO RELATED APPLICATIONS

This application is based upon and claims the benefit of priority from the prior Japanese Patent Application No. 2002-318862, filed Oct. 31, 2002, the entire contents of which are incorporated herein by reference.

### BACKGROUND OF THE INVENTION

1. Field of the Invention

The present invention relates to a method of adjusting a servo optimum point in, e.g., a focus servo or a tilt servo in an optical disk apparatus.

2. Description of the Related Art

When recording or reproducing information to/from an optical disk by using a light beam, the light beam is condensed on an optical disk surface by using a lens. At this moment, the lens is generally controlled so as to maintain a position of just focusing. Maintaining this just focusing state enables efficient recording or reproduction of information.

In recent years, however, when recording information in a high-density recording medium such as a DVD and reproducing the recorded information, a just focusing position is slightly different from a lens position at which a reflected light ray, i.e., an RF signal can be most efficiently received. A difference between the just focusing lens position and the lens position at which the reflected light ray can be most efficiently received is generally called a focus offset.

Increasing a mechanical accuracies of a lens and an optical pickup can suppress this focus offset. An improvement in the mechanical accuracies of the lens and the optical pickup, however, involves an increase in cost of a product. In order to most efficiently receive the reflected light from the optical pickup, therefore, it is required to detect the focus offset and adjust the focus offset by shifting the lens from the just focusing position by a distance corresponding to the focus offset. Processing to detect and adjust the focus offset in this manner is called focus offset adjustment.

Jpn. Pat. Appln. KOKAI Publication No. 2002-15439 discloses a focus offset adjusting method. In this publication, first, it is determined that an apparatus is in a first mode in which an outer peripheral test area is used. Then, each change value of the focus offset is used to obtain averages of error rates of reproduction data of three sectors and four sectors in one truck of the disk. An optimum focus offset is obtained from a quadric approximation curve of the focus offset and the error rate concerning the three sectors in the truck. Further, an optimum focus offset is obtained from a quadric approximation curve of the focus offset and the error rate concerning the four sectors in the truck. These optimum focus offsets are added and averaged, thereby acquiring a final focus offset.

Thereafter, it is determined that the apparatus is in a second mode in which an inner peripheral test area is used, and a final focus offset is likewise obtained. A focus offset in each zone of the disk is obtained by a liner interpolation and the like using the final focus offsets acquired in the first and second modes, and results are stored in a memory as set values.

In the prior art, an error rate is obtained in order to adjust the focus offset. In case of a low error rate like le⁻⁶, data of at least le⁶ bits must be analyzed in order to calculate the error rate. Moreover, in analysis of approximately le⁶ bits, since the error rate is affected by a noise and the like, a correct value cannot be obtained. Thus, in order to perform accurate calculation, data of le⁸ bits must be analyzed.

As described above, the prior art has a problem that large amount of data must be analyzed in order to obtain a servo optimum point.

### BRIEF SUMMARY OF THE INVENTION

In the present invention, when the optical disk apparatus adopts an adaptive control type PRML signal processing method, an optimum point of a servo condition in a focus servo or a tilt servo is obtained by using a convergent value of an equalization coefficient of an adaptive equalizer.

That is, the optical disk apparatus according to an embodiment of the present invention is an optical disk apparatus which decodes data recorded in an optical disk by using PRML signal processing, the optical disk apparatus comprising: an optical pickup which irradiates the optical disk with a light beam, receives a reflected light and provides a reproduction signal corresponding to the reflected light; a servo offset setting portion which sets a servo offset of the optical disk apparatus; an adaptive equalizer which is adaptively controlled by using a signal decoded by the PRML signal processing and waveform-equalizes the reproduction signal provided from the optical pickup; and a servo offset change portion which obtains an optimum point of the servo offset by using a control result of the adaptive equalizer and changes a set value of the servo offset setting portion.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of an optical disk apparatus to which the present invention is applied;

FIG. 2 is a block diagram showing only a structure of a focus offset adjustment portion according the present invention extracted from the structure depicted in FIG. 1;

FIG. 3 is a block diagram showing an adaptive equalizer extracted from the circuit configuration depicted in FIG. 2;

FIGS. 4A and 4B are views showing beam intensity distributions on an information recording plane of an optical disk;

FIG. 5 is a flowchart showing processing to detect a focus offset optimum point;

FIG. 6 is a block diagram showing a structure of a tangent tilt offset adjustment portion according to the present invention extracted from the structure depicted in FIG. 1;

FIGS. 7A and 7B are views showing another beam intensity distributions on the information recording plane of the optical disk; and

FIG. 8 is a flowchart showing processing to detect a tangential tilt optimum point.

### DETAILED DESCRIPTION OF THE INVENTION

An embodiment according to the present invention will now be described in detail hereinafter with reference to the accompanying drawings. The following description is an embodiment according to the present invention, and it does not restrict an apparatus and a method according to the present invention.

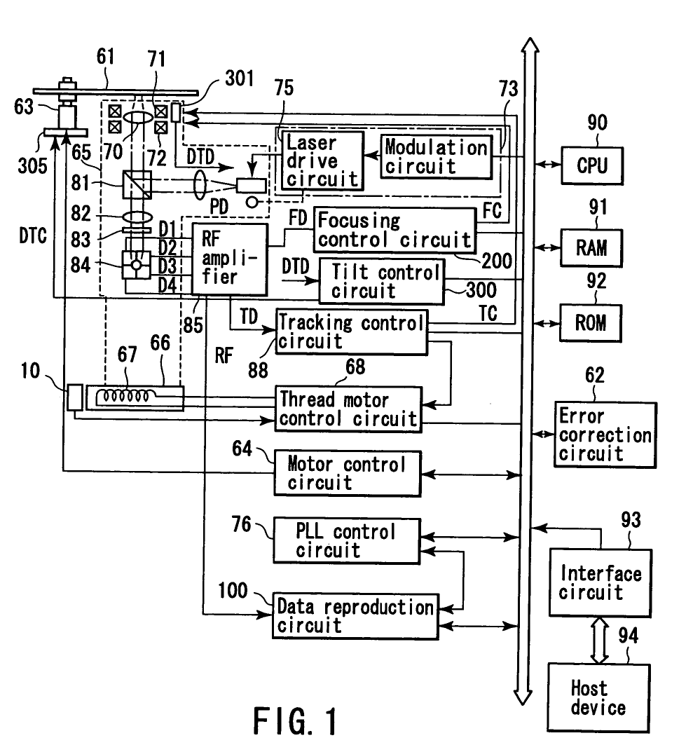

FIG. 1 is a block diagram showing a structure of an optical disk apparatus to which the present invention is applied.

An optical disk 61 is an optical disk dedicated to reading or an optical disk on which user data can be recorded. The disk 61 is rotated and driven by a spindle motor 63. Recording and reproduction of information with respect to the optical disk 61 are carried out by an optical pickup head (which will be referred to as a PUH hereinafter) 65. The PUH 65 is connected to a thread motor 66 through a gear, and this thread motor 66 is controlled by a thread motor control circuit 68.

A seek destination address of the PUH 65 is inputted to the thread motor control circuit 68 from a CPU 90, and the thread motor control circuit 68 controls the thread motor 66 based on this address. A permanent magnet is fixed inside the thread motor 66, and a drive coil 67 is excited by the thread motor control circuit 68, thereby moving the PUH 65 in a radial direction of the optical disk 61.

To the PUH 65 is provided an object lens 70 supported by a wire or a flat spring which is not illustrated. The object lens 70 can move in a focusing direction (direction of an optical axis of the lens) by drive of a drive coil 72, and can move in a tracking direction (direction orthogonal to the optical axis of the lens) by drive of a drive coil 71.

A laser beam is emitted from a semiconductor laser 79 by a laser drive circuit 75 in a laser control circuit 73. The optical disk 61 is irradiated with the laser beam emitted from the semiconductor laser 79 through a collimator lens 80, a half prism 81 and the object lens 70. A reflected light ray from the optical disk 61 is led to a photodetector 84 through the object lens 70, the half prism 81, a condensing lens 82 and a cylindrical lens 83.

The photodetector 84 consists of, e.g., four divided photodetector cells, and a detection signal from each divided photodetector cell is outputted to an RF amplifier 85. The RF amplifier 85 combines signals from the photodetector cells, and outputs a focusing detection signal FD, a tracking detection signal TD and a full addition signal RF. The focusing detection signal FD is one set of signals obtained by adding outputs from the photodetector cells provided on a diagonal line. That is, the focusing detection signal FD corresponds to two signals “D1+D3” and “D2+D4” provided that outputs from the respective photodetector cells are D1, D2, D3 and D4. The tracking detection signal TD is one sent of signals obtained by adding outputs from the adjacent photodetector cells. That is, the tracking detection signal TD corresponds to two signals “D1+D2” and “D3+D4”. The full addition signal RF is a signal “D1+D2+D3+D4” obtained by adding outputs from the four photodetector cells.

A focusing control circuit 200 generates a focus control signal FC based on the focusing detection signal FD. The focus control signal FC is supplied to the drive coil 72 which moves the lens 70 in a focusing direction, and the focus servo that the laser beam is always just focused on a recording film of the optical disk 61 is carried out.

A tracking control circuit 88 generates a tracking control signal TC based on the tracking detection signal TD. The tracking control signal TC is supplied to the drive coil 72 which moves the lens 70 in a tracking direction, and the tracking servo that the laser beam always traces a track formed on the optical disk 61 is carried out.

A tilt sensor 301 irradiates the optical disk 61 with a tilt detection light beam, receives its reflected light ray by a PSD (position sensing device), and detects a tilt of the disk 61. A detection output, i.e., a disk tilt detection signal DTD from the tilt sensor 301 is supplied to a tilt control circuit 300.

The tilt control circuit 300 generates a disk tilt control signal DTC based on the disk tilt detection signal DTD. The disk tilt control signal DTC is supplied to a tilt drive portion 305, and an inclination of the spindle motor 63 is controlled so as to eliminate the tilt of the disk 61.

When the focus servo, the tracking servo and the tilt control are executed, a change in the reflected light from, e.g., a pit formed on the track of the optical disk 61 is reflected to the full addition signal RF of the output signals from the respective photodetector cells of the photodetector 84. This signal is supplied to a data reproduction circuit 100. The data reproduction circuit 100 decodes information by the PRML mode processing based on a reproduction clock signal from a PLL circuit 76.

When the object lens 70 is controlled by the tracking control circuit 88, the thread motor 66, i.e., the PUH 65 is controlled by the thread motor control circuit 68 in such a manner that the object lens 70 is placed in the vicinity of a predetermined position in the PUH 65.

The motor control circuit 64, the thread motor control circuit 68, the laser control circuit 73, the PLL circuit 76, the data reproduction circuit 100, the focusing control circuit 200, the tracking control circuit 88, an error correction circuit 62 and others are controlled by a CPU 90 through a bus 89. The CPU 90 comprehensively controls this recording/reproducing apparatus in accordance with an operation command provided from a host device through an interface circuit 93. Additionally, the CPU 90 uses an RAM 91 as a working area, and performs a predetermined operation in accordance with a program recorded in an ROM 92.

Description will now be given as to a method of adjusting a servo offset in, e.g., a focus servo, a tilt servo or the like to an optimum point according to the present invention. First, focus offset adjustment will be explained.

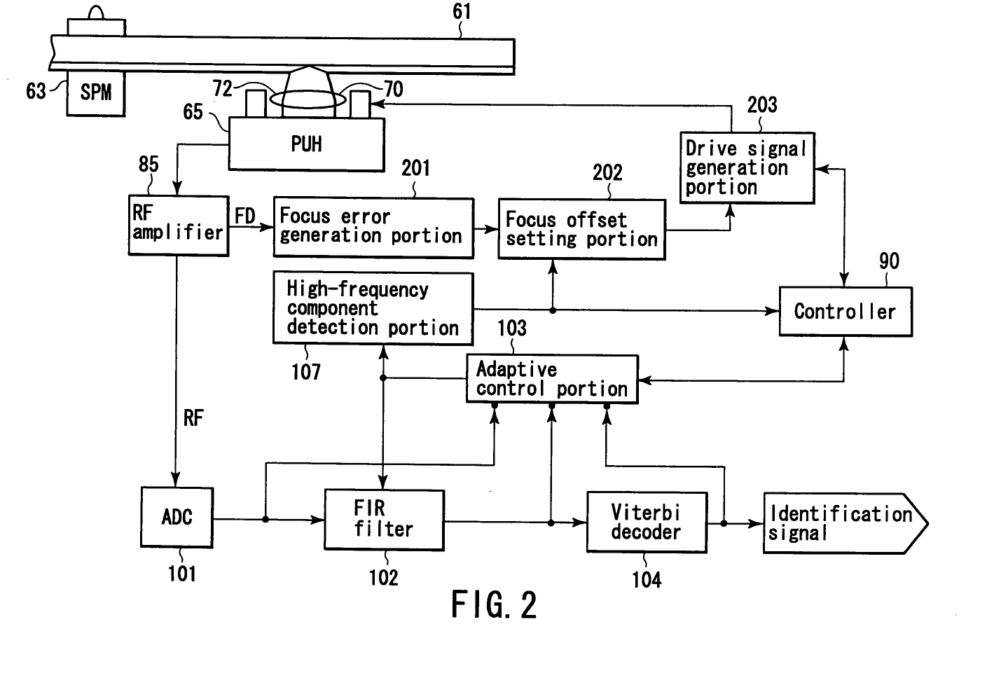

FIG. 2 is a block diagram showing a structure of a primary part of this embodiment extracted from the structure depicted in FIG. 1. Like reference numerals denote elements equal to those in FIG. 1. An AD converter 101, an FIR filter 102, an adaptive control portion 103, a Viterbi decoder 104 and a high-frequency component detection portion 107 are circuit elements included in a data reproduction circuit 100. A focus error generation portion 201, a focus offset setting portion 202 and a drive signal generation portion 203 are circuit elements included in the focusing control circuit 200.

The focus error generation portion 201 generates a focus error signal indicative of a focus error from the focusing detection signal FD provided from the RF amplifier 85. The focus offset setting portion 202 adds a predetermined quantity of offset to a focus control quantity used to reduce the focus error signal to zero and outputs a result thereof based on the focus error signal generated by the focus error generation portion 201. The drive signal generation portion 203 converts the control quantity provided from the focus offset setting portion 202 into a current value used to drive the lens drive portion 72.

Description will now be given as to a focus offset adjusting method using an equalization coefficient of the adaptive equalizer when the focus offset deviates from an optimum point.

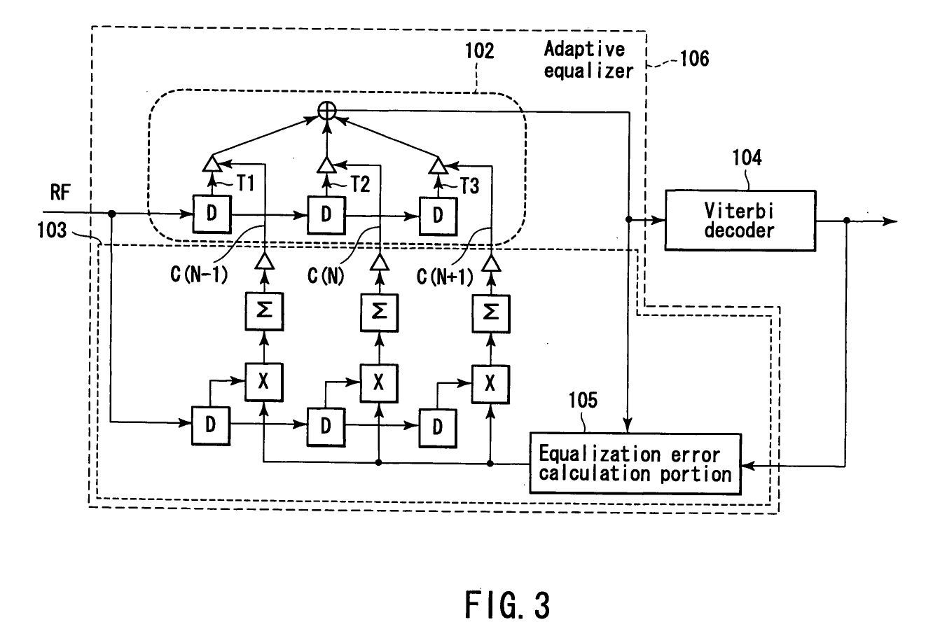

FIG. 3 is a view showing an adaptive equalizer 106 extracted from the circuit configuration depicted in FIG. 2 in detail. The adaptive equalizer 106 includes an FIR filter 102 and an adaptive control portion 103. In this embodiment, description will be given as to a case that a Viterbi decoder has even-numbered constraint length (number of taps is an odd number). Assuming that N is a natural number, the adaptive equalizer 106 is constituted by using the FIR filter having (2N+1) taps. The adaptive equalizer 106 shown in FIG. 3 has three taps T1 to T3, for example.

The FIR filter 102 and the Viterbi decoder 104 are constituent elements of a PRML signal processing circuit. In the PRML signal processing, the equalizer subjects a reproduction signal to waveform equalization so as to change an isolated response waveform of the reproduction signal and comply with a PR class of the Viterbi decoder on a rear stage. The Viterbi decoder 104 outputs an ideal waveform after decoding. An equivalent error calculation portion 105 generates a control signal based on a difference between an output value of the FIR filter 102 and an output value of the Viterbi decoder 104.

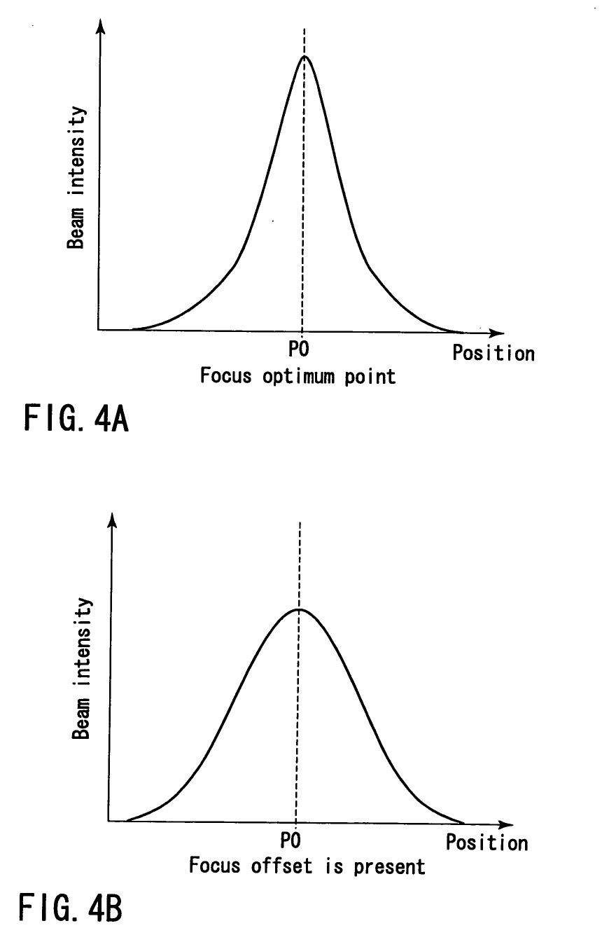

When the focus offset deviates from an optimum point, an intensity distribution of the beam on an information recording plane of the optical disk is distorted as shown in FIG. 4B. In FIG. 4, a position of P0 is a position of an optical axis. Such a distortion of the intensity distribution of the beam provokes a change in isolated response waveform. More concretely, when the intensity distribution of the beam is increased, and a high-frequency component in the reproduction signal is thereby decreased.

When the high-frequency component in the reproduction signal is decreased in this manner, the adaptive equalizer 106 is controlled to perform waveform equalization so as to comply with the PR class of the Viterbi decoder 104 on the rear stage. That is, the adaptive equalizer 106 is controlled so as to obtain an equalizer characteristic which restore the high-frequency component which has been lost due to deviation of the focus offset from the optimum point.

Description will now be given as to a tap coefficient of the adaptive equalizer 106 having the above-described equalizer characteristic.

Assuming that the nth tap coefficient is C(n), a central value C(N) is generally maximum. When a gain in the high-frequency component of a transfer function of the equalizer (FIR filter) is large (e.g., when a focus error is generated), a difference between the Nth tap coefficient C(N) and each of the N+lth and N-lth tap coefficients C(N-1) and C(N+1) is large. That is, it is good enough to correct the focus offset in such a manner that differences between C(N-1) and C(N) and between C(N+1) and C(N) becomes minimum. It is to be noted that these tap coefficients correspond to multiplication values of the respective taps in the FIR filter.

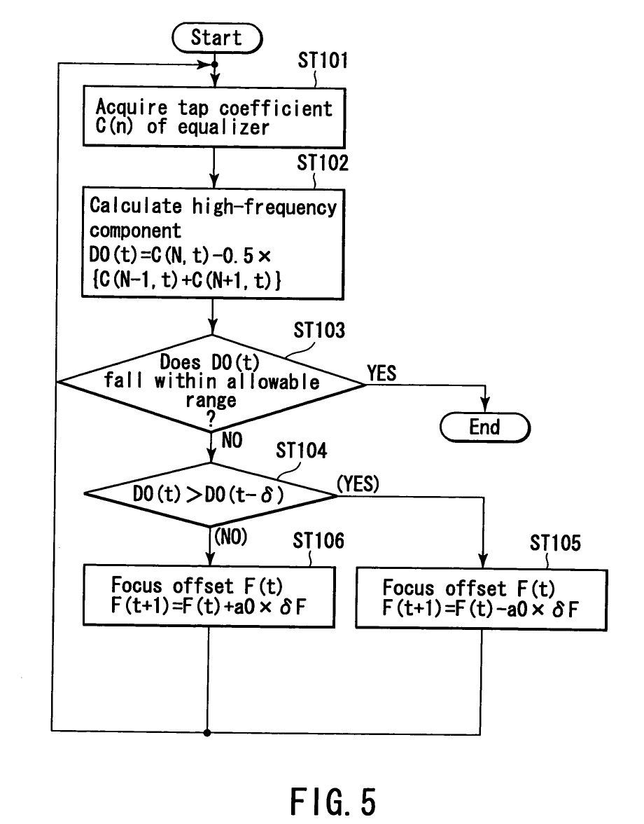

FIG. 5 is a flowchart showing processing to detect a focus offset optimum point. This processing is executed by a controller (CPU) 90.

A high-frequency component detection portion 107 obtains tap coefficients in the FIR filter 102. The controller 90 acquires the tap coefficient C(n) through the high-frequency component detection portion 107, and calculates a high-frequency component DO(t) as a difference between a central tap coefficient C(N, t) and an average value of tap coefficients C(N-1, t) and C(N+1, t) on the both sides (ST 101 and 102).

D0(t)=C(N, t)−0.5×{C(N−1, t)+C(N+1, t)}

It is to be noted that the high-frequency component D0(t) may be obtained as an average value of values calculated as described above for a plurality of times in a predetermined period. Moreover, the high-frequency component detection portion 107 may calculate each average value of the respective tap coefficients in a predetermined period and obtain the high-frequency component D0(t) by using the average value. In this case, the influence of the noise can be suppressed.

At a step 103, a judgment is made upon whether the high-frequency component D0(t) falls within an allowable range. This allowable range correspond to values determined in accordance with a specification of a system. When the high-frequency component D0(t) is large beyond the allowable range (No at the step 103), a judgment is made upon whether the current high-frequency component D0(t) is larger than a precedently calculated high-frequency component D0(t−δ) (ST 104). Here, δ is a calculation cycle of the high-frequency component.

When the current high-frequency component D0(t) is larger than the precedently calculated high-frequency component D0(t−δ) (YES at the step 104), the focus offset F(t+1) is calculated as follows.

F(t+1)=F(t)−a0×δF

where a0 is a sensitivity of the focus offset control system, and δF is a minimum value of the adjustable focus offset. In this manner, the controller 90 changes the offset set value of the focus offset setting portion 202. It is to be noted that, when the current high-frequency component D0(t) is larger than the precedently calculated high-frequency component D0(t−δ), whether a focus offset adjustment quantity “a0×δF” is subtracted from the current offset value F(t) like the step 105 or it is added to the focus offset F(t) is determined in accordance with the polarity of the lens drive portion or the like.

At a step 104, when the current high-frequency component D0(t) is not more than the precedently calculated high-frequency component D0(t−δ) (NO), the focus offset F(t+1) is calculated as follows (ST 106).

F(t+1)=F(t)+a0×δF

In this case, whether the focus offset adjustment quantity “a0×δF” is added to the current offset F(t) or it is subtracted from the focus offset value F(t) is likewise determined in accordance with the polarity of the lens drive portion or the like.

As described above, the focus offset can be adjusted by using the tap coefficient of the adaptive equalizer. According to the present invention, an optimum point of the servo offset can be carried out in periods of a channel bit number which is smaller than that in the prior art. Additionally, the optimum point of the servo offset can be adjusted without analyzing the recorded data like the prior art (e.g., calculating the error rate).

Incidentally, when the odd-numbered constraint length are used, the adaptive equalizer is constituted by the FIR filter having even-numbered (2N) taps. C(N−1) and C(N+1) correspond to the central tap coefficient, and the tap coefficients on the both sides are C(N−2) and C(N+2). It is good enough to correct the focus offset in such a manner that a difference between C(N−2) and C(N−1) and a difference between C(N+2) and C(N+1) respectively become minimum.

Another embodiment according to the present invention will now be described.

As realization of a higher density of information recorded on the optical disk advances, the influence of the disk tilt on recording/reproduction becomes large. When a tilt is generated in the disk, a signal recording characteristic is lowered, and a crosstalk in signal reproduction is increased. Here, the tilt indicates an angle formed by an optical axis of the laser beam and a perpendicular line of the information recording plane of the disk, and a tilt in the disk radial direction is called a radial tilt whilst a tilt in the track tangential line direction on the disk is called a tangential tilt. In this embodiment, the tangential tilt is adjusted by using the tap coefficient of the adaptive equalizer circuit.

Description will now be given as to a correction method using the equalization coefficient of the adaptive equalizer when the tangential tilt deviates from the optimum point.

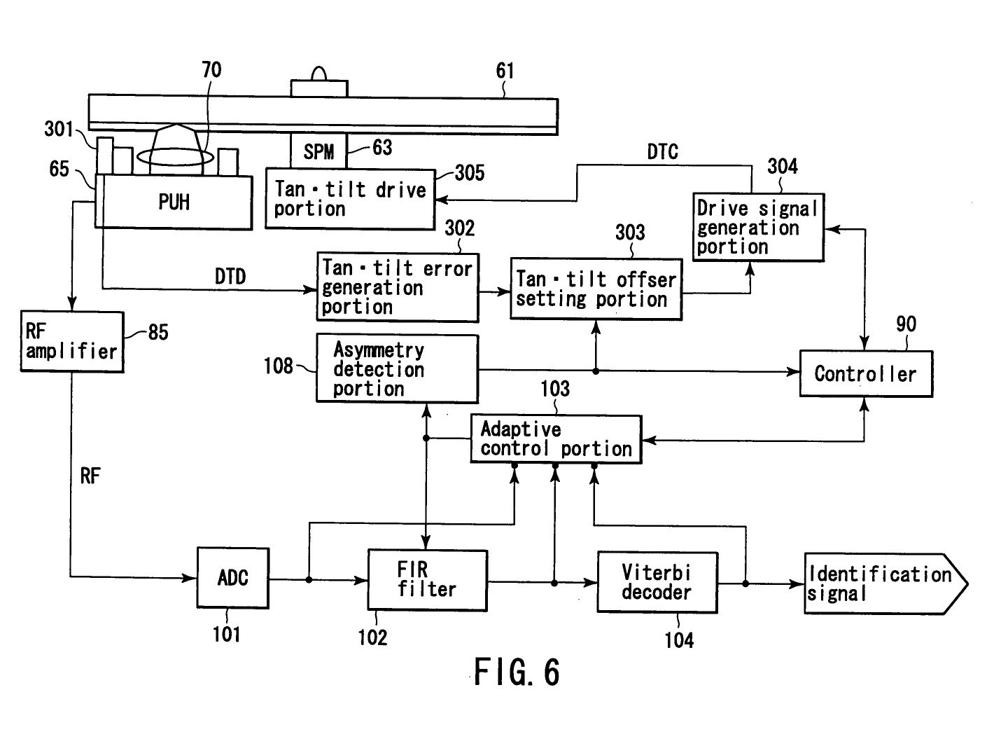

FIG. 6 is a block diagram showing a structure of a primary part of this embodiment extracted from the structure depicted in FIG. 1 in detail. Like reference numerals denote elements equal to those in FIG. 1. A tangential tilt error generation portion 302, a tangential tilt offset setting portion 303 and a drive signal generation portion 304 are circuit elements included in a tilt control circuit 300. An asymmetry detection portion 108 is a circuit element included in a reproduction circuit 100.

The tangential tilt error generation portion 302 generates a tangential tilt error signal from a disk tilt detection signal DTD supplied from a tilt sensor 301. The tangential tilt offset setting portion 303 gives a predetermined quantity of offset to a tangential tilt control quantity used to reduce the tangential tilt error signal to zero based on the tangential tilt error signal generated by the tangential tilt error generation portion 302, and outputs a result. The drive signal generation portion 304 converts the control quantity provided from the tangential tilt offset setting portion 303 into a current value used to drive the tangential tilt drive portion 305.

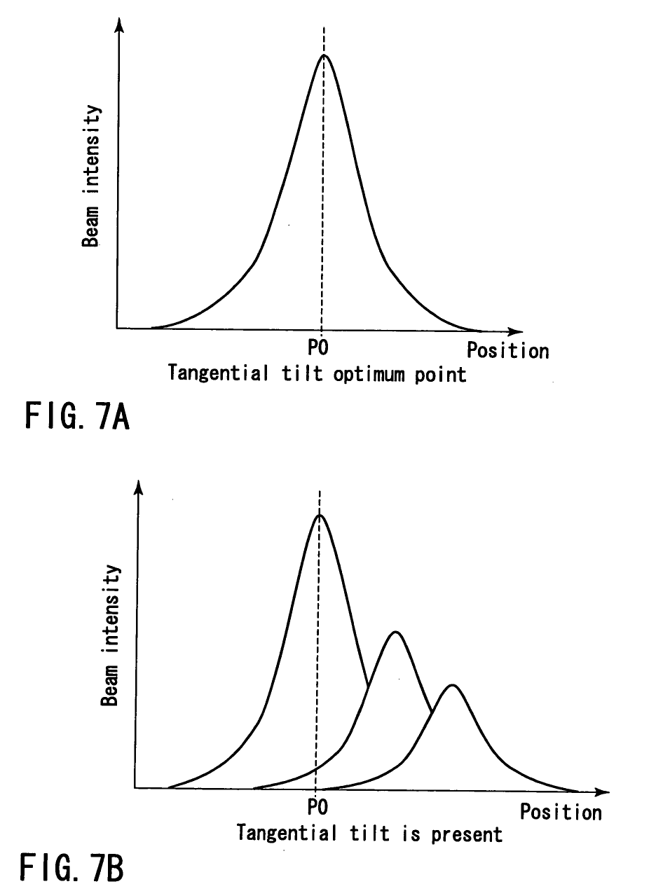

When the tangential tilt deviates from the optimum point, an intensity distribution of the beam on the information recording plane of the optical disk is distorted as shown in FIG. 7B. An isolated waveform response varies due to such a distortion of the intensity distribution of the beam. More concretely, since the intensity distribution of the beam becomes asymmetric in the vicinity of a mark due to the disk tilt, the isolated response waveform also becomes asymmetric in the vicinity of the mark.

When the isolated response waveform is asymmetric in the vicinity in this manner, the adaptive equalizer 106 of FIG. 3 is controlled in such a manner that the isolated response waveform becomes symmetric in the vicinity. A Viterbi decoder 104 on the rear stage performs decoding processing on the assumption that the isolated waveform response is symmetric in the vicinity. Therefore, the adaptive equalizer 106 is controlled so as to obtain the equalizer characteristic with the asymmetry opposite to the signal characteristic in order to correct the asymmetry of the isolated waveform response in the vicinity.

Description will now be given as to a case that the Viterbi decoder has even-numbered constraint length (number of taps is an odd number) in regard to the tap coefficient of the adaptive equalizer 106 having the above-described equalizer characteristic.

Assuming that the nth tap coefficient is C(n), when the tangential tilt is an optimum point, the tap coefficient becomes substantially symmetric with a central value C(N) at the center. That is,

C(N−i)≈C(N+i)

where i is an integer value satisfying i<N. On the other hand, assuming that the tangential tilt deviates from the optimum point by θdeg, the following expression can be obtained.

C(N−i)+a(i)×f(θ)

≈C(N+i)−a(i)×f(θ)

where f(θ) is a function of θ, and corresponds to an increasing function. In general, since the tap coefficient close to the center has a larger absolute value, it is good enough to compare the N−1th and N+1th tap coefficients C(N−1) and C(N+1) and correct the tangential tilt quantity in such a manner that a difference between these coefficients becomes minimum.

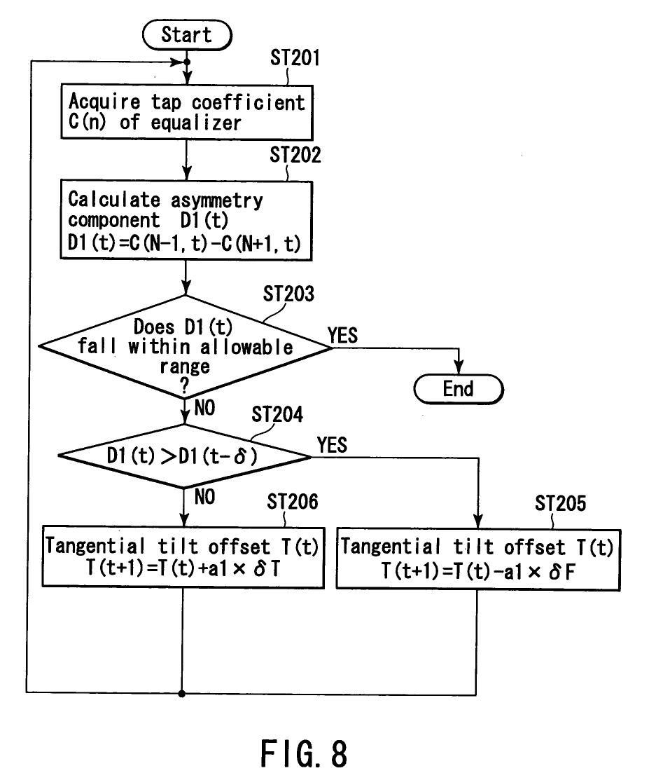

FIG. 8 is a flowchart showing processing to detect the tangential tilt optimum point. This processing is executed by the controller (CPU) 90.

An asymmetry detection portion 108 holds the tap coefficient of the adaptive equalizer 106. The controller 90 acquires the tap coefficient C(n) through the asymmetry detection portion 108, and calculates the asymmetry D1(t) as a difference between the tap coefficients C(N−1, t) and C(N+1, t) on the both sides of the central tap coefficient C(N, t) (ST 201 and 202).

D1(t)=C(N−1, t)−C(N+1, t)

It is to be noted that the asymmetry D1(t) may be obtained as an average value of values calculated for a plurality of times in a predetermined period. Furthermore, the asymmetry detection portion 108 may calculate each average value of the respective tap coefficients in a predetermined period and obtain the asymmetry D1(t) by using this average value. In this case, the influence of the noise can be suppressed.

At a step 203, a judgment is made upon whether the asymmetry D1(t) falls within an allowable range. This allowable range is values determined in accordance with a specification of a system. When the asymmetry D1(t) is large beyond the allowable range (NO at the step 203), a judgment is made upon whether the current asymmetry D1(t) is larger than the precedently calculated asymmetry D1(t−δ) (ST 204). Here, 5 is a calculation cycle of the asymmetry.

When the current asymmetry D1(t) is larger than the precedently calculated asymmetry D1(t−δ) (YES at a step 204), the tangential tilt offset T(t+1) is calculated as follows (ST 205).

T(t+1)=T(t)−a1×δT

where a1 is a sensitivity of the tangential offset control system, and δT is a minimum value of the adjustable tangential tilt offset. Incidentally, when the current asymmetry D1(t) is larger than the precedently calculated asymmetry D1(t−δ), whether a tangential tilt offset adjustment quantity “a1×δT” is subtracted from the current tangential tilt offset value T(t) like the step 205 or whether it is added to the tangential tilt offset T(t) is determined in accordance with the polarity of the tangential tilt drive portion or the like.

At the step 24, when the current asymmetry D1(t) is not more than the precedently calculated asymmetry D1(t−δ) (NO), the tangential tilt offset T(t+1) is calculated as follows (ST 206).

T(t+1)=T(t)+a1×δT

In this case, whether the tangential tilt offset adjustment quantity “a1×δT” is added to the current tangential tilt offset value T(t) or whether it is subtracted from the tangential tilt offset value T(t) is determined in accordance with the polarity of the tilt drive portion or the like.

As described above, the tangential tilt offset can be adjusted by using the tap coefficient of the adaptive equalizer.

Incidentally, when the Viterbi decoder has the odd-numbered constraint length, the adaptive equalizer is constituted by the FIR filter having the even-numbered (2N) tap coefficients. When the tangential tilt is an optimum point, the tap coefficient C(n) becomes substantially symmetric with C(N−1) and C(N+1) at the center. It is good enough to compare the N−2th and N+2th tap coefficients C(N−2) and C(N+2) and correct the tangential tilt quantity in such a manner that this difference becomes minimum by the similar method when the Viterbi decoder has the even-numbered constraint length.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An optical disk apparatus which decodes data recorded in an optical disk by PRML (Partial Response and Maximum Likelihood) signal processing, comprising:
an optical pickup which irradiates the optical disk with a light beam, receives a reflected light ray therefrom, and provides a reproduction signal corresponding to the reflected light ray;
a servo offset setting portion which sets a servo offset of a servo system concerning the optical pickup;
an adaptive equalizer which is controlled by a signal decoded by the PRML signal processing and performs waveform equalization on the reproduction signal provided from the optical pickup; and
a servo offset change portion which obtains an optimum point of the servo offset by using a control result of the adaptive equalizer, and changes a set value of the servo offset setting portion.

2. The optical disk apparatus according to claim 1, wherein the adaptive equalizer includes an FIR filter, and the servo offset change portion obtains an optimum point of the servo offset by using a tap coefficient of the FIR filter.

3. The optical disk apparatus according to claim 2, wherein the servo offset setting portion has a focus offset setting portion which sets a focus offset quantity of the light beam, and
the servo offset change portion has a focus offset change portion which obtains an optimum value of a focus offset by using a control result of the adaptive equalizer and changes a focus offset quantity of the focus offset setting portion.

4. The optical disk apparatus according to claim 3, further comprising a high-frequency component detection portion which detects an amplitude value concerning a high-frequency component of the adaptive equalizer, wherein the focus offset change portion obtains an optimum value of the focus offset based on the amplitude value of the high-frequency component detected by the high-frequency component detection portion.

5. The optical disk apparatus according to claim 4, wherein, provided that the PRML signal processing has even-numbered constraint length, a tap number of the FIR filter is 2N−1, and a value of the nth tap coefficient at a time t is expressed as C(t, n), the focus offset change portion adjusts the focus offset quantity in such a manner that the following expression becomes minimum:
C(t, N)−{C(t, N1)+C(t, N−1)}/2.

6. The optical disk apparatus according to claim 4, wherein, provided that the PRML signal processing has odd-numbered constraint length, a tap number of the FIR filter is 2N, and a value of the nth tap coefficient at a time t is expressed as C(t, n), the focus offset change portion adjusts the focus offset quantity in such a manner that the following expression becomes minimum:
[{C(N−1)−C(N−2)}+{C(N+1)−C(N+2)}]/2

7. The optical disk apparatus according to claim 2, wherein the servo offset setting portion has a tangential tilt offset setting portion which sets a tilt offset quantity in a tangential direction of the optical disk, and
the servo offset change portion has a tangential tilt offset change portion which changes the tangential tilt offset to an optimum value by using a control result of the adaptive equalizer.

8. The optical disk apparatus according to claim 7, further comprising an asymmetry detection portion which detects an asymmetry of the adaptive equalizer in a direction of a time base, wherein the tangential tilt offset change portion adjusts a tangential tilt offset quantity in such a manner that the asymmetry detected by the asymmetry detection portion becomes minimum.

9. The optical disk apparatus according to claim 8, wherein, provided that the PRML signal processing has even-numbered constraint length, a tap number of the FIR filter is 2N−1, and a value of the nth tap number at a time t is expressed as C(t, n), the tangent tilt offset change portion adjusts the tangential tilt offset quantity in such a manner that the following expression becomes minimum:
{C(t, N+1)−C(t, N−1)}.

10. The optical disk apparatus according to claim 8, wherein, provided that the PRML signal processing has odd-numbered constraint length, a tap number of the FIR filter is 2N, and a value the nth tap coefficient at a time t is expressed as C(t, n), the tangent tilt offset change portion adjusts the tangential tilt offset quantity in such a manner that the following expression becomes minimum:
{C(t, N+2)−C(t, N−2)}.

11. A servo offset adjustment method in an optical disk apparatus which decodes data recorded in an optical disk by using PRML signal processing, comprising:
setting a servo offset of a servo system concerning an optical pickup;
subjecting a reproduction signal provided from the optical pickup to waveform equalization by using an FIR filter;
controlling a tap coefficient of the FIR filter based on a signal decoded by the PRML signal processing; and
obtaining an optimum point of the servo offset based on the tap coefficient of the FIR filter and changing the servo offset.
